(19) United States
(12) Patent Application Publication
(10) Pub. No.: US 2008/0147615 A1
(43) Pub. Date: Jun. 19, 2008

(54) Xpath based evaluation for content stored in a hierarchical database repository using xmlindex

(75) Inventors: Man-Hay Tam, Belmont, CA (US); Thomas Baby, Foster Ctiy, CA (US); Nipun Agarwal, Santa Clara, CA (US); Ravi Murthy, Fremont, CA (US); Sivasankaran Chandrasekar, Palo Alto, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: ORACLE INTERNATIONAL CORPORATION, REDWOOD SHORES, CA (US)

(21) Appl. No.: 11/641,419

(22) Filed: Dec. 18, 2006

(51) Int. Cl. G06F 17/30

(52) U.S. Cl. 707/3; 707/E17.069

(57) ABSTRACT

A method and apparatus for efficiently processing a query that specifies a location path and a content path is provided. The location path identifies the hierarchical location of a set of documents within a resource hierarchy. The content path identifies hierarchical location of one or more nodes within the content of the set of documents. Computing the query includes using a resource hierarchy index, based on the location path, to generate first results corresponding to the set of documents. Computing the query also includes using a content index, based on the content path, to generate second results corresponding to the one or more nodes. Final results of the query are based on the first results and second results by, for example, joining the first and second results.

### RELATED CASES

This application is related to U.S. Pat. No. 6,427,123, entitled HIERARCHICAL INDEXING FOR ACCESSING HIERARCHICALLY ORGANIZED INFORMATION IN A RELATIONAL SYSTEM, filed on Feb. 19, 1999, the contents of which are herein incorporated by reference in their entirety for all purposes.

This application is related to U.S. Pat. No. 7,051,033, entitled PROVIDING A CONSISTENT HIERARCHICAL ABSTRACTION OF RELATIONAL DATA, filed on Sep. 27, 2002, the contents of which are herein incorporated by reference in their entirety for all purposes.

This application is related to U.S. patent application Ser. No. 10/260,381, entitled MECHANISM TO EFFICIENTLY INDEX STRUCTURED DATA THAT PROVIDES HIERARCHICAL ACCESS IN A RELATIONAL DATABASE SYSTEM, filed on Sep. 27, 2002, the contents of which are herein incorporated by reference in their entirety for all purposes.

This application is related to U.S. patent application Ser. No. 10/884,311, entitled INDEX FOR ACCESSING XML DATA, filed on Jul. 2, 2004, the contents of which are herein incorporated by reference in their entirety for all purposes.

This application is related to U.S. patent application Ser. No.______ [Attorney Docket No. 50277-3132], entitled QUERYING AND FRAGMENT EXTRACTION WITHIN RESOURCES IN A HIERARCHICAL REPOSITORY, filed on Dec. _{—}, 2006, the contents of which are herein incorporated by reference in their entirety for all purposes.

### FIELD OF THE INVENTION

The present invention relates generally to computing queries on XML data, and more specifically to efficiently computing queries that include location paths and content paths.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Documents may be stored in repositories that are hierarchically organized. Indexes, such as those in U.S. Pat. No. 6,427,123 and U.S. patent application Ser. No. 10/260,381, index each document's location (hereinafter referred to as “location path”) in a resource hierarchy and are used to process queries that request documents based on their respective location paths in the resource hierarchy.

Some documents, such as XML documents, are hierarchically organized. As a result, content within such documents may be specified by a content path. A content path identifies one or more nodes within such documents.

A query that targets documents in the resource hierarchy may specify both a location path and a content path. In order to evaluate such a query, a resource hierarchy index is used, based on the location path, to identify the appropriate documents. Thereafter, the identified documents are, based on the content path, read according to the query. However, reading a document, such as an XML document, requires significant system resources to manifest the entire document and traverse the tree-like structure of the document to the appropriate node(s) based on the content path.

Thus, there is a need to provide a more efficient mechanism to process queries that include both a location path and a content path.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart that illustrates an approach for executing a query that includes a location path and a content path, according to an embodiment of the invention;

FIG. 2A illustrates a tree-like structure of a resource hierarchy;

FIG. 2B illustrates a resource table that stores resources in a resource hierarchy, according to an embodiment of the invention;

FIG. 2C illustrates a resource hierarchy index based on the resource hierarchy of FIG. 1A, according to an embodiment of the invention;

FIG. 3 illustrates a resource table and an out-of-line purchase order table of XML documents that conform to a purchase order schema, according to an embodiment of the invention; and

FIG. 4 shows a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. For example, the following description discusses XML documents; however, embodiments of the invention are not limited to XML documents. Any type of resource that can be indexed based on the resource's content and location in a hierarchy may be queried on. In other instances, well-known structures and devices are shown in block diagram form in order to avoid unnecessarily obscuring the present invention.

### Overview

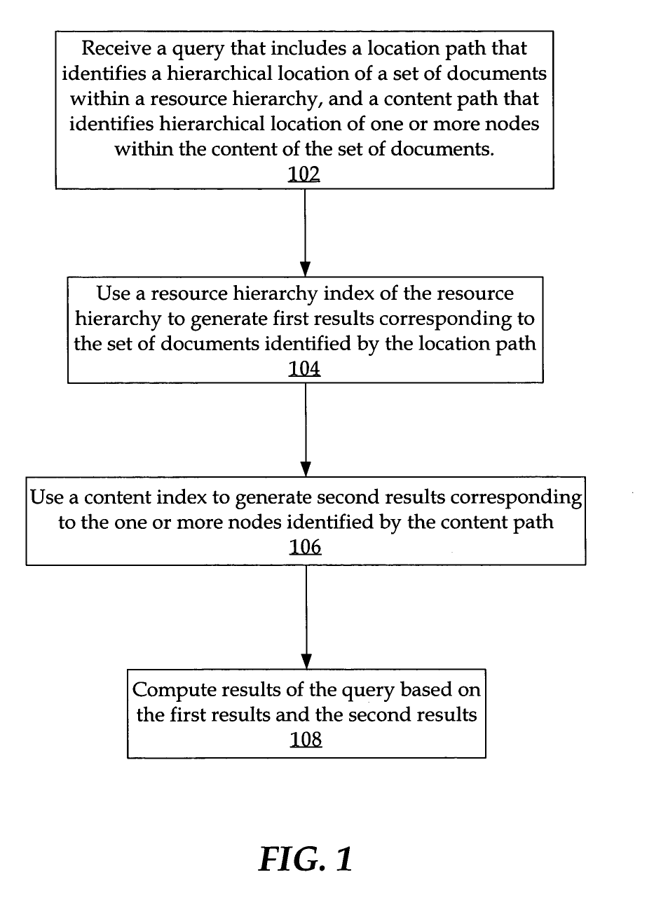

FIG. 1 is a flow chart that illustrates an approach for efficiently executing a query that includes a location path and a content path, according to an embodiment of the invention. Two types of indexes are used. The first index is a resource hierarchy index, which indexes a document's location within a resource hierarchy. The second index is a content index which indexes the path of nodes within multiple documents.

Referring to FIG. 1, at step 102, a query is received that includes a location path and a content path. At step 104, the resource hierarchy index is used to generate first results corresponding to the set of documents identified by the location path. At step 106, the content index is used to generate second results corresponding to the one or more nodes identified by the content path. At step 108, results of the query are computed based on the first results and the second results. Embodiments of the invention are not limited to the order in which steps 104 and 106 are performed. Thus, steps 104 and 106 may be performed in any order or even in parallel.

### Resource Hierarchy

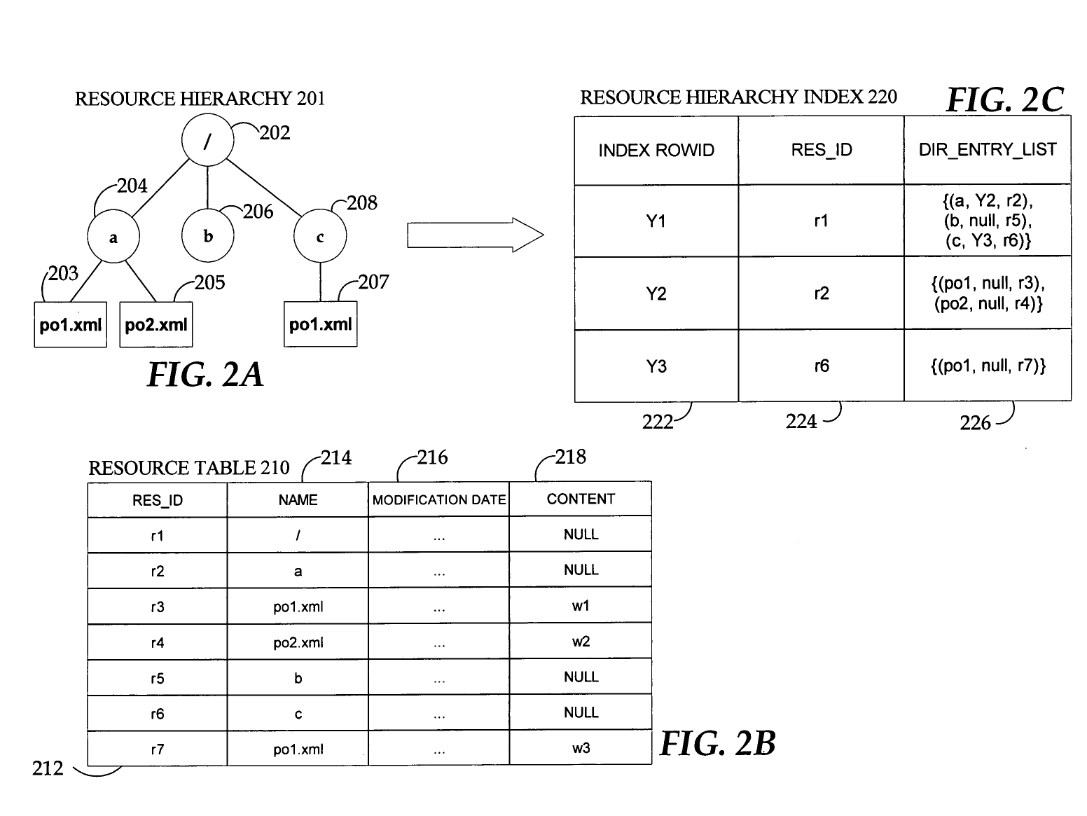

According to an embodiment, resource hierarchy structures are used to represent the resource hierarchy of a collection of documents. These structures are used to determine what documents fall within a path. The structures include a resource hierarchy index and a resource table, described further below. These structures are illustrated within the context of exemplary resource hierarchy 201, shown in FIG. 2A.

Exemplary resource hierarchy 201 includes numerous directories arranged in a hierarchy. Three documents 203, 205, and 207 are stored in the directories. Specifically, documents 203, 205, and 207, which are respectively entitled “po1.xml”, “po2.xml”, and “po1.xml”, are respectively stored in directories 204, 206, and 208, which are respectively entitled “a”, “b”, and “c”.

In the directory hierarchy, directories 204, 206, and 208 are children of directory 202. Directory 202 is referred to as the “root” directory because it is the directory from which all other directories descend. In many systems, the symbol “/” is used to refer to the root directory.

When electronic information is organized in a hierarchy, each item of information may be located by following a “path” through the hierarchy to the entity that contains the item. Within a resource hierarchy, the location path to an item begins at the root directory and proceeds down the hierarchy of directories to eventually arrive at the directory that contains the item of interest. For example, the path to document 205 consists of directories 202 and 204, in that order.

A convenient way to identify and locate a specific item of information stored in a hierarchical storage system is through the use of a “pathname”. A pathname is a concise way of uniquely identifying a resource (e.g., either a directory or a document) based on the path through the hierarchy to the item. A pathname is composed of a sequence of names, referred to as path elements. In the context of a resource hierarchy, each name in the sequence of names is a “resource name”. The term “resource name” refers to both the names of directories and the names of documents, since both directories and documents are considered to be “resources”.

Within a resource hierarchy, the sequence of resource names in a given pathname begins with the name of the root directory, includes the names of all directories along the path from the root directory to the item of interest, and terminates in the name of the item of interest. Typically, the list of directories to traverse is concatenated together, with some kind of separator punctuation (e.g., ‘/’, ‘\’, or ‘;’) to make a pathname. Thus, the pathname for document 203 is /a/po1.xml, while the pathname for document 207 is /b/po1.xml.

### Resource Table

FIG. 2B is a diagram that illustrates a resource table 210 that contains an entry for each document in the repository. Each entry includes a ResID 212, a Name 214, a modification date 216, and a content column 218. However, a resource table may comprise more or less columns. For example, resource table 210 may comprise system-maintained information such as creation date, access permission information, etc.

The ResID is a unique row identifier assigned to each row of resource table 210 by the database system. Because a row in resource table 210 corresponds to one resource within resource hierarchy 201, the row ID in ResID can serve as a resource identifier for the resource and, if the resource is a document, as a document identifier for the document. The content field may store the actual contents of a resource or document in the form of a binary large object (BLOB), or a pointer to the contents of the resource or document. Where the entry is for a resource having no content (e.g. a directory), the body field is null. In the above example, only the three XML documents have content; thus, the body field for each of the other entries is null.

### Resource Hierarchy Index

FIG. 2C shows a resource hierarchy index 220, which may be used to emulate a hierarchical storage system in a database. Resource hierarchy index 220 is based on resource hierarchy 201 of FIG. 2A. The Index RowID 222 column contains system generated row identifiers that identify a row in a table. The Res_ID 224 field of an index entry stores the document identifier of the document. According to an embodiment, the document identifier is the row identifier corresponding to a row in resource table 210.

The Dir_entry_list 226 field of the index entry for a given directory stores, in an array, an “array entry” for each of the child resources of the given directory. According to one embodiment of the invention, resource hierarchy index 220 only stores index entries for items that have children.

For example, index entry corresponding to index rowID Y2 is for the ‘a’ directory. The ‘po1.xml’ file and the ‘po2.xml’ file are children of the ‘a’ directory. Hence, the Dir_entry_list field of the above index entry includes an array entry for the ‘po1.xml’ file and an array entry for the ‘po2.xml’ file.

U.S. patent application Ser. No. 10/260,381 referenced above describes how resource hierarchy index 220 may be used to access a document based on the location path of the document.

### Out-of-Line Content

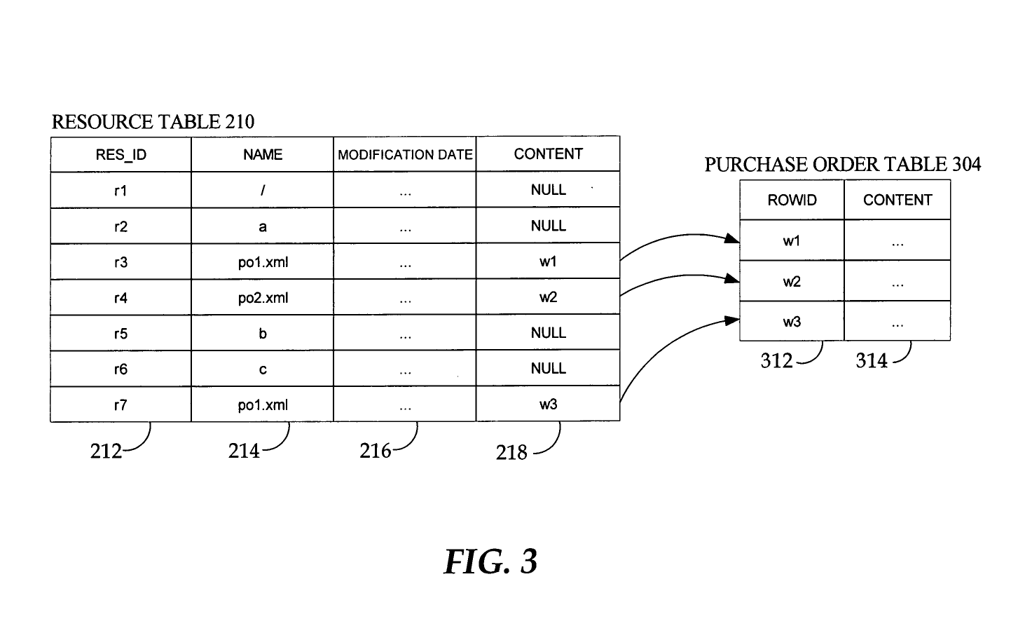

FIG. 3 is a diagram that illustrates out-of-line content, and specifically illustrates a purchase order table 304 of XML documents that conform to a purchase order schema, according to an embodiment of the invention. Entries corresponding to resources that have out-of-line content contain a reference to that out-of-line content. For example, the entry corresponding to po1.xml has a reference w1 in the content 218 column. Reference w1 “points” to an entry in purchase order table 304, which comprises of at least two columns RowID 312 and content 314. The content of po1.xml resides in the content 314 column corresponding to reference w1.

### Content Index

For the purpose of explanation of a content index, examples shall be given hereafter with reference to the following two XML documents:

```
po1.xml
<PurchaseOrder>
  <Reference>SBELL-2002100912333601PDT</Reference>
  <Actions>
    <Action>
      <User>SVOLLMAN</User>
    </Action>
  </Actions>
. . . .
</PurchaseOrder>
po2.xml
<PurchaseOrder>
  <Reference>ABEL-20021127121040897PST</Reference>
  <Actions>
    <Action>
      <User>ZLOTKEY</User>
    </Action>
    <Action>
      <User>KING</User>
    </Action>
  </Actions>
. . . .
</PurchaseOrder>
```

As indicated above, po1.xml and po2.xml are merely two examples of XML documents. The techniques described herein are not limited to XML documents having any particular types, structure or content. Examples shall be given hereafter of how documents with hierarchically-organized content would be indexed and accessed according to various embodiments of the invention.

According to one embodiment, a content index is a domain index that improves the performance of queries that include Xpath-based predicates and/or Xpath-based fragment extraction. A content index can be built, for example, over both XML Schema-based as well as schema-less XMLType columns which are stored either as CLOB or structured storage. In one embodiment, a content index is a logical index that results from the cooperative use of a path index, a value index, and an order index.

The path index provides the mechanism to lookup fragments based on simple (navigational) path expressions. The value index provides the lookup based on value equality or range. There could be multiple secondary value indexes. The order index associates hierarchical ordering information with indexed nodes. The order index is used to determine parent-child, ancestor-descendant and sibling relationships between XML nodes.

### The Path Table

According to one embodiment, a content index includes a PATH table, and a set of secondary indexes. As mentioned above, each indexed document may include many indexed nodes. The PATH table contains one row per indexed node. For each indexed node, the PATH table row for the node contains various pieces of information associated with the node.

In one embodiment, the documents that are indexed by the content index are XML documents. In a related embodiment, one or more XML documents in the resource hierarchy conform to one XML schema and one or more other XML documents in the resource hierarchy conform to another XML schema and or no XML schema.

According to one embodiment, the information contained in the PATH table includes (1) a pathname that indicates the path to the node, (2) “location data” for locating the fragment data for the node within the base structures, and (3) “hierarchy data” that indicates the position of the node within the structural hierarchy of the XML document that contains the node. Optionally, the PATH table may also contain value information for those nodes that are associated with values. Each of these types of information shall be described in greater detail below.

### Paths

The structure of an XML document establishes parent-child relationships between the nodes within the XML document. The “path” for a node in an XML document reflects the series of parent-child links, starting from a “root” node, to arrive at the particular node. For example, the path to the “User” node in po2.xml is /PurchaseOrder/Actions/Action/User, since the “User” node is a child of the “Action” node, the “Action” node is a child of the “Actions” node, and the “Actions” node is a child of the “PurchaseOrder” node.

The set of XML documents that a content index indexes is referred to herein as the “indexed XML documents”. According to one embodiment, a content index may be built on all of the paths within all of the indexed XML documents, or a subset of the paths within the indexed XML documents. Techniques for specifying which paths are indexed are described hereafter. The set of paths that are indexed by a particular content index are referred to herein as the “indexed XML paths”.

### Path Table Example

According to one embodiment, the PATH table includes columns defined as specified in the following table:

| Column | | |
|---|---|---|
| Name | Datatype | Description |
| PATH | RAW(8) | Pathname of the corresponding node in a |
| | | document |
| RESID | URESID/ | ResID of the document (that corresponds to the |
| | RESID | node) in the resource table (e.g., resource |
| | | table 210) that maintains documents and |
| | | other resources of the resource hierarchy. |
| VALUE | RAW(2000)/ | Value of the node in case of attributes and simple |
| | BLOB | elements. |
| | | The type can be specified by the user (as well as |
| | | the size of the RAW column) |

As explained above, the PATH is the pathname of the associated node. PATH may instead be (or include) an identifier that uniquely represents the pathname of a node.

The VALUE column stores the effective text value for simple element (i.e. no element children) nodes and attribute nodes. According to one embodiment, adjacent text nodes are coalesced by concatenation. As shall be described in greater detail hereafter, a mechanism is provided to allow a user to customize the effective text value that gets stored in VALUE column by specifying options during index creation e.g. behavior of mixed text, whitespace, case-sensitive, etc can be customized. The user can store the VALUE column in any number of formats, including a bounded RAW column or a BLOB. If the user chooses bounded storage, then any overflow during index creation is flagged as an error.

The PATH table may include other columns (not shown), such as a column for the order key of a node and a column for a locator of a node. The order key of a node is a Dewey ordering number of the node. The internal representation of the order key may preserve document ordering. A locator of a node indicates at least the starting position for the fragment corresponding to the node. The locator is used during fragment extraction.

The following table is an example of a PATH table that (1) has the columns described above, and (2) is populated with entries for po1.xml and po2.xml. Specifically, each row of the PATH table corresponds to an indexed node of either po1.xml or po2.xml. In this example, po1.xml and po2.xml are respectively stored at rows R3 and R4 of a base (i.e., resource) table (see FIG. 2B).

POPULATED PATH TABLE

| rowid | Path | Resid | Value |
|---|---|---|---|
| 1 | /PurchaseOrder | r3 | |
| 2 | /PurchaseOrder/Reference | r3 | SBELL- |
| | | | 2002100912333601PDT |
| 3 | /PurchaseOrder/Actions | r3 | |
| 4 | /PurchaseOrder/Actions/Action | r3 | |
| 5 | /PurchaseOrder/Actions/Action/ | r3 | SVOLLMAN |
| | User | | |
| 6 | /PurchaseOrder | r4 | |
| 7 | /PurchaseOrder/Reference | r4 | ABEL- |
| | | | 20021127121040897PST |
| 8 | /PurchaseOrder/Actions | r4 | |
| 9 | /PurchaseOrder/Actions/Action | r4 | |
| 10 | /PurchaseOrder/Actions/Action/ | r4 | ZLOTKEY |
| | User | | |
| 11 | /PurchaseOrder/Actions/Action | r4 | |
| 12 | /PurchaseOrder/Actions/Action/ | r4 | KING |
| | User | | |

In this example, the rowid column stores a unique identifier for each row of the PATH table. Depending on the database system in which the PATH table is created, the rowid column may be an implicit column. For example, the disk location of a row may be used as the unique identifier for the row. Secondary Order and Value indexes may use the rowid values of the PATH table to locate rows within the PATH table.

In the embodiment illustrated above, the PATHID and VALUE of a node are all contained in a single table. In an alternative embodiment, separate tables may be used to map the PATHID and VALUE information to corresponding location data (e.g. the base table Resid and Locator).

### Secondary Indexes

The PATH table may include the information required to locate the XML documents, or XML fragments, that satisfy a wide range of queries. However, without secondary access structures, using the PATH table to satisfy such queries will often require full scans of the PATH table. Therefore, according to one embodiment, a variety of secondary indexes are created by the database server to accelerate the queries that (1) perform path lookups and/or (2) identify order-based relationships. According to one embodiment, the following secondary indexes are created on the PATH table.
PATHID_INDEX on (pathid, rid)
ORDERKEY_INDEX on (rid, order-key)
VALUE INDEXES
PARENT_ORDERKEY_INDEX on (rid, SYS_DEWEY_PARENT(order_key))

### Using a Resource Hierarchy Index and a Content Index in Executing a Query

According to an embodiment of the invention, a resource hierarchy index and a content index may both be used to execute queries that include both a location path and a content path. For example, the query may be:

select PurchaseOrder/Reference from resource_table
where under_path(‘/a’) > 0
and existNode(/PurchaseOrder/Actions/Action/User, Svollman);

Execution of this query, using a database server that manages a database, selects all purchase order reference nodes that are associated with XML documents that satisfy both conditions specified in the WHERE clause. One condition is that the XML document must be found under the ‘/a’ path. The other condition is that a node within the XML document must have a ‘/PurchaseOrder/Actions/Action/User’ node with ‘Svollman’ as its value.

When the database server receives this query, the database server determines that a resource hierarchy index and a content index may be used to satisfy the specified conditions. The database server may rewrite the query to reference the content index. During execution of the query, the order in which the indexes are accessed may be irrelevant. In fact, the indexes may be accessed in parallel by multiple threads of execution.

The resource hierarchy index is used to determine the resource identifiers corresponding to XML documents that are found under the path ‘/a’. As described above, the resource hierarchy index may associate documents that are indexed by the resource hierarchy index with row identifiers. A row identifier of a document may serve as a resource or document identifier that corresponds to the documents. According to FIG. 2C, resource identifiers r3 and r4 are associated with documents under the path ‘/a’ and are returned as a result of using the resource hierarchy index 220.

The content index is used to determine the resource identifiers corresponding to all XML documents that have a ‘/PurchaseOrder/Actions/Action/User’ content path, where the ‘User’ node has a value of “Svollman”. Both the fifth and tenth row of the populated path table above have a column with the same path as the specified content path. Because, the fifth row of the populated path table has the same value as the specified value, the corresponding row (or resource) identifier ‘r3’ is returned. Because the resource identifier ‘r3’ is the only common resource identifier in both sets of results, the row in resource table 210 with ‘r3’ as the resource identifier may be accessed to determine the value of the ‘PurchaseOrder/Reference’ node as specified in the query. Whether the actual content of the document corresponding to ‘r3’ is stored in resource table 210 or is stored separately therefrom (i.e. out-of-line content), the document (i.e., po1.xml in this example) may be manifested and traversed to retrieve the value of the ‘PurchaseOrder/Reference’ node.

In one embodiment, the resource identifiers in the separate results generated by traversal of both indexes are used to join the separate results.

Thus, queries that include both a location path and a content path are executed more efficiently by avoiding computation-expensive operations to manifest, unnecessarily, entire XML documents and/or avoiding iteratively checking whether XML documents satisfy a specified location path.

### Hardware Overview

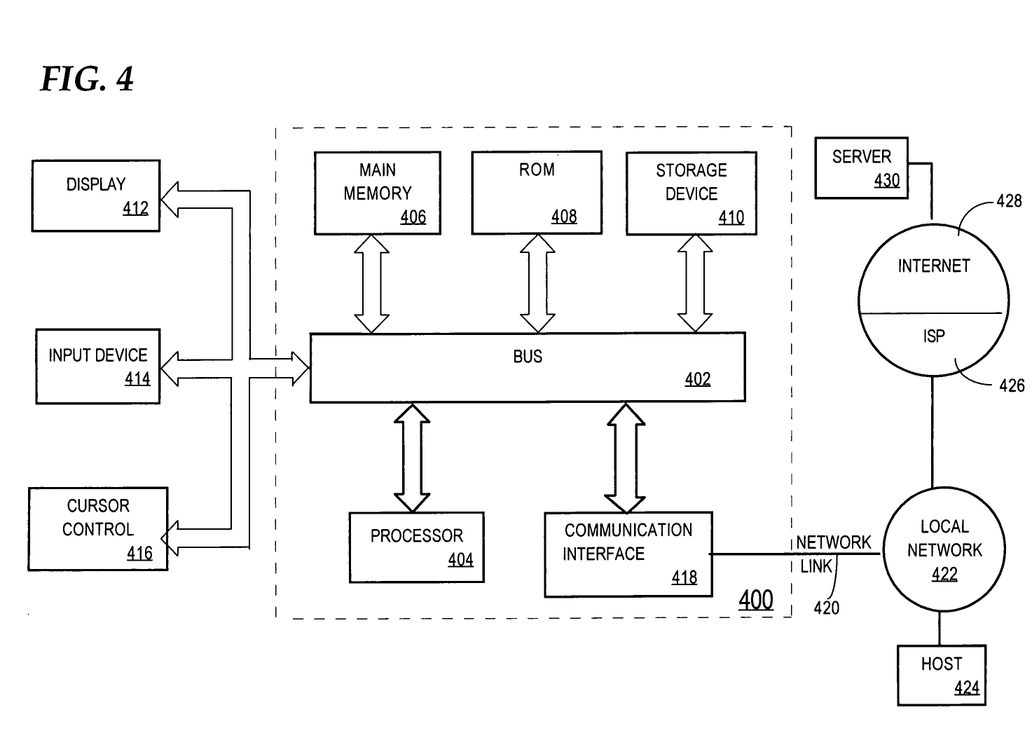

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A machine-implemented method, comprising:
receiving a query that includes:
a location path that identifies the hierarchical location of a set of documents within a resource hierarchy, and
a content path that identifies the hierarchical location of one or more nodes within the content of the set of documents; and
computing the query, wherein computing includes:
using, based on the location path, a first index of the resource hierarchy to generate first results corresponding to the set of documents,
using, based on the content path, a second index that indexes the nodes within the content of the set of documents to generate second results corresponding to the one or more nodes, and
computing results of the query based on the first results and the second results.

2. The method of claim 1, wherein computing results of the query includes performing a join operation between the first results and the second results.

3. The method of claim 1, wherein each document in said set of documents is an XML document.

4. The method of claim 1, wherein the second index indexes only nodes of the set of documents that are indicated by a set of location paths.

5. The method of claim 4, wherein a user specifies said set of location paths.

6. The method of claim 1, wherein:
a first subset of said set of documents conform to a first schema; and
a second subset of said set of documents conform to a second schema.

7. The method of claim 1, wherein:
computing results of the query includes accessing a resource table that comprises a plurality of rows; and
each row of the plurality of rows:
corresponds to a document in the set of documents, and
contains a resource identifier associated with the corresponding document.

8. The method of claim 7, wherein:
a first subset of the set of documents are stored in the corresponding row of the resource table; and
a second subset of the set of document are stored in a table that is separate from the resource table.

9. The method of claim 1, wherein receiving the query and computing the query are performed by a database server.

10. The method of claim 9, wherein the database server rewrites the query to reference the second index.

11. A machine-readable medium carrying one or more sequences of instructions which, when executed by one or more processors, causes the one or more processors to perform the method recited in claim 1.

12. A machine-readable medium carrying one or more sequences of instructions which, when executed by one or more processors, causes the one or more processors to perform the method recited in claim 2.

13. A machine-readable medium carrying one or more sequences of instructions which, when executed by one or more processors, causes the one or more processors to perform the method recited in claim 3.

14. A machine-readable medium carrying one or more sequences of instructions which, when executed by one or more processors, causes the one or more processors to perform the method recited in claim 4.

15. A machine-readable medium carrying one or more sequences of instructions which, when executed by one or more processors, causes the one or more processors to perform the method recited in claim 5.

16. A machine-readable medium carrying one or more sequences of instructions which, when executed by one or more processors, causes the one or more processors to perform the method recited in claim 6.

17. A machine-readable medium carrying one or more sequences of instructions which, when executed by one or more processors, causes the one or more processors to perform the method recited in claim 7.

18. A machine-readable medium carrying one or more sequences of instructions which, when executed by one or more processors, causes the one or more processors to perform the method recited in claim 8.

19. A machine-readable medium carrying one or more sequences of instructions which, when executed by one or more processors, causes the one or more processors to perform the method recited in claim 9.

20. A machine-readable medium carrying one or more sequences of instructions which, when executed by one or more processors, causes the one or more processors to perform the method recited in claim 10.
